(19) United States
(12) Patent Application Publication
(10) Pub. No.: US 2010/0043274 A1
(43) Pub. Date: Feb. 25, 2010

(54) Bed bug trap

(75) Inventor: Antonio Washington Battick, West Hempstead, NY (US)

Correspondence Address: Antonio W. Battick, 289 Colonial Rd, West Hempstead, NY, 11552, US

(73) Assignee: Antonio Washington Battick, West Hempstead, NY (US)

(21) Appl. No.: 12/229,013

(22) Filed: Aug. 19, 2008

(51) Int. Cl. A01M 1/14

(52) U.S. Cl. 43/114

(57) ABSTRACT

A system for catching bed bugs, which is created in the form of a strip. This strip is affixed around the perimeter of the mattress or box spring of a bed. This trap which is flat in appearance is comprised of a continuous recessed pocket throughout the entire strip. Within this recessed pocket lays a coating of a gelatinous substance: The Trapping Agent. The bedbug trap is attached to an average bed with the aid of embedded elastic for flexibility and a snug fit.

### BACKGROUND

Bed bugs have been a huge problem both locally and internationally. These insects live in, or close to people's bed, traveling up the bed at night to attack their human prey. This is when our Bed bugs Barrier Trap works best and is most effective in catching these pests.

### SPECIFICATION

Our Bed bug Trap is a discrete strip that has a recessed pocket that is lined with an insect catching adhesive. This strip is anchored around the bedding via the aid of a stretchable material, such as an elastic band, which ensures a snug fit around the bed. The bed bug trap is designed in such a way to allow sheets, clothing or skin to come in contact with the device but not with the trapping adhesive.

The trapping process takes place when people are sleeping in bed and bed bugs start traveling up the bed towards their victim. Before they reach their destination, they must first attempt to pass over the Trapping strip. While doing so, they are forced to enter the adhesive filled recessed pocket, from which they have no escape.

### DESCRIPTION OF THE DRAWING

The accompanying drawings illustrate the invention.

In such drawings:

FIG. 1 is a perspective drawing that shows an apparatus for ensnaring bed bugs. The bed bug trap 3 encircles the mattress 1 approximately one third above its base, which rests on the box spring 2.

FIG. 2 is a cross sectional view of the apparatus. The strip 3 is comprised of a flexible material with shape memory such as rubber. The recessed pocket is filled with an adhesive 4 of a gelatinous nature.

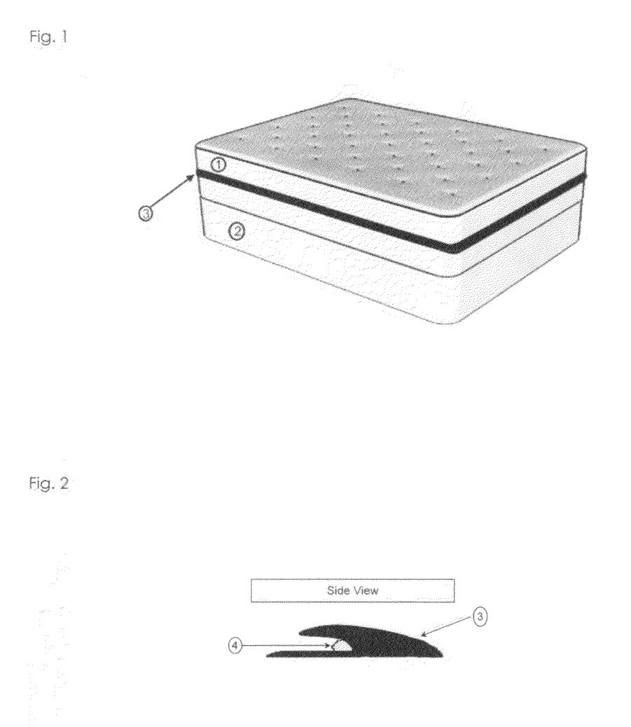

What is claimed is

1. A bed bug trap which compromises:
A strip surrounding a bed or of such embodiment which incorporates a recessed pocket which is coated with a gelatinous adhesive.

2. The structure of claim 1 wherein said surrounding strip is made of a shape memory material but not limited to such.

3. The structure of claim 1 wherein said means for securing compromised of but is not limited to an elastic strip attached to the ends.
